(19) United States
(12) Patent Application Publication
(10) Pub. No.: US 2023/0181939 A1
(43) Pub. Date: Jun. 15, 2023

(54) WEARABLE AIR PURIFIER

(71) Applicant: Dyson Technology Limited, Wiltshire (GB)

(72) Inventors: Michael James LEAT, Swindon (GB); Simon Brian MCNAMEE, Bristol (GB)

(73) Assignee: Dyson Technology Limited, Wiltshire (GB)

(21) Appl. No.: 17/923,493

(22) PCT Filed: Mar. 11, 2021
(86) PCT No.: PCT/GB2021/050604

§ 371 Date: Nov. 4, 2022

(30) Foreign Application Priority Data
May 18, 2020 (GB) 2007317.7

(51) Int. Cl. A62B 18/00; A62B 7/10; A62B 18/02

(52) U.S. Cl. CPC A62B 18/006; A62B 7/10; A62B 18/025

(57) ABSTRACT

A wearable air purifier includes a headgear, an air purifier assembly and a nozzle assembly. The air purifier assembly includes a filter and an airflow generator for creating an airflow through the filter. The nozzle assembly includes a conduit for receiving a filtered airflow from the air purifier assembly, and an outlet body releasably connected to the conduit. The outlet body defines an air outlet for emitting filtered airflow from the nozzle assembly.

### FIELD OF THE INVENTION

The present invention relates to a wearable air purifier.

### BACKGROUND OF THE INVENTION

Air pollution is an increasing problem and a variety of air pollutants have known or suspected harmful effects on human health. The adverse effects that can be caused by air pollution depend upon the pollutant type and concentration, and the length of exposure to the polluted air. For example, high air pollution levels can cause immediate health problems such as aggravated cardiovascular and respiratory illness, whereas long-term exposure to polluted air can have permanent health effects such as loss of lung capacity and decreased lung function, and the development of diseases such as asthma, bronchitis, emphysema, and possibly cancer.

In locations with particularly high levels of air pollution, many individuals have recognised the benefits of minimising their exposure to these pollutants and have therefore taken to wearing face masks with the aim of filtering out at least a portion of the pollutants present in the air before it reaches the mouth and nose. There have also been various attempts to develop air purifiers that can be worn by the user but that do not require the wearer's mouth and nose to be covered. For example, there are various designs for wearable air purifiers that are worn around the neck of the wearer and that create a jet of air that is directed upwards towards the wearer's mouth and nose. It is important for such wearable air purifiers to provide unpolluted air to a wearer throughout the lifetime of the purifier.

### SUMMARY OF THE INVENTION

According to a first aspect of the present invention there is provided a wearable air purifier comprising a headgear; an air purifier assembly, the air purifier assembly comprising a filter and an airflow generator for creating an airflow through the filter; and a nozzle assembly comprising a conduit for receiving a filtered airflow from the air purifier assembly, and an outlet body releasably connected to the conduit, the outlet body defining an air outlet for emitting filtered airflow from the nozzle assembly.

The wearable air purifier according to the first aspect of the present invention may be beneficial principally as the nozzle assembly comprises a conduit for receiving a filtered airflow from the air purifier assembly, and an outlet body releasably connected to the conduit, the outlet body defining an air outlet for emitting filtered airflow from the nozzle assembly.

In particular, as the outlet body is releasably connected to the conduit, the outlet body may be easily removed and separated from the conduit to allow for cleaning of the outlet body. For example the outlet body may be separated from the conduit and placed in a cleaning solution, or placed under UV light, which may eliminate bacteria and/or other pollutants from the outlet body, thereby ensuring the airflow emitted from the nozzle assembly in use is as clean as possible for the wearer. Furthermore, such an arrangement may enable ease of cleaning for the conduit, and in some examples may enable ease of access to an interior of the conduit for cleaning.

The nozzle assembly may be supported by the headgear. The nozzle assembly may be directly connected to the headgear, for example with no intervening components therebetween, or may be indirectly connected to the headgear, for example with one or more intervening components therebetween.

The air purifier assembly may be supported by the headgear. The air purifier assembly may be directly connected to the headgear, for example with no intervening components therebetween, or may be indirectly connected to the headgear, for example with one or more intervening components therebetween.

The air purifier assembly may not be supported by the headgear. The air purifier assembly may be arranged to be worn elsewhere on the body of wearer (e.g. on a belt or around the neck of the wearer). The air purifier assembly may be fluidically connected to the nozzle assembly ducting that is connected to the headgear.

The outlet body may comprise a final component of the wearable air purifier through which filtered airflow travels before being emitted to a wearer. For example, there may be no components of the wearable air purifier downstream of the outlet body through which filtered airflow passes in use, and filtered airflow may be emitted from the air outlet, and hence from the wearable air purifier, toward the mouth and nasal region of a wearer in use.

The conduit may be configured to convey received filtered airflow to the air outlet of the outlet body in use. For example, the conduit may comprise an inlet aperture configured to receive filtered airflow from an outlet aperture of the air purifier assembly, and a generally tubular body at least partially defining a flow passage from the inlet aperture to the air outlet of the outlet body. The combination of the conduit and the outlet body, when connected to the conduit, may define a flow passage from the inlet aperture to the air outlet. The conduit may be connected to the air purifier assembly, for example such that the inlet aperture is in fluid communication with the outlet aperture.

The nozzle assembly may be configured such that, in use, with the headgear located on a head of a wearer, the nozzle assembly extends in front of a face of the wearer, for example such that the air outlet is located in a region of a mouth and/or lower nasal region of the wearer. The nozzle assembly may be configured such that, in use, the nozzle assembly extends in front of a face of the wearer without contacting the face of the wearer. This may provide an arrangement with increased comfort for the wearer, for example relative to an arrangement where the nozzle assembly contacts a face of a wearer in use. The nozzle assembly may be generally elongate and arcuate in form. The air outlet may be substantially centrally located along the nozzle assembly.

The conduit may comprise an aperture, and the outlet body may be configured to extend over the aperture when the outlet body is connected to the conduit in use. The combination of the conduit and the outlet body, when connected to the conduit, may define a flow passage from the inlet aperture of the conduit to the air outlet. The outlet body may be shaped and dimensioned to fit on the conduit over the aperture. The conduit may be generally arcuate and thereby define a void between a first end and a second end of the conduit, a head of a wearer being received within the void in use. The aperture may be formed in a wearer facing side of the conduit, for example in a side wall of the conduit facing inwardly toward a void defined between a first end and a second end of the conduit.

The outlet body may comprise a plurality of apertures defining the air outlet. An air outlet comprising a plurality of apertures may allow for improved delivery of airflow to a wearer compared to, for example, a single aperture spanning the same surface area as the total surface area of the plurality of apertures. In particular, a plurality of apertures may provide less turbulent and/or more directional airflow.

The plurality of apertures may be distributed, for example as an array, across an outlet region of the outlet body. The outlet region may comprise a total open area, defined by the apertures, of from 4500 mm² to 6900 mm², from 4700 mm² to 6700 mm², or approximately 5700 mm². The outlet region may comprise an open area of from 15% to 28%, from 18% to 25%, or approximately 18%. The plurality of apertures may have an aperture size (e.g. width or diameter) of from 50 μm to 150 μm.

The outlet region may have a maximum length may be at least 90 mm, of from 100 mm to 130 mm, or of approximately 125 mm. The outlet region may have a maximum height may be at least 50 mm, of from 50 mm to 65 mm, or of approximately 60 mm.

The outlet body may comprise a mesh defining the air outlet, for example with the mesh comprising the plurality of apertures. Alternatively, the plurality of apertures may be provided by perforations provided within the outlet region. For example, the plurality of apertures may be provided by holes formed in the outlet body itself or by a perforated sheet disposed within the outlet region of the outlet body.

At least one of the conduit and the outlet body may comprise a seal for sealing with the other of the outlet body and the conduit when the outlet body is connected to the conduit in use. This may prevent leakage of filtered airflow from a region of the join between the conduit and the outlet body in use. The outlet body may comprise the seal, and this may, for example, provide for ease of cleaning when the outlet body is removed from the conduit, for example. The seal may extend about a perimeter of the outlet body or a perimeter of the aperture of the conduit. The seal may comprise a resiliently deformable material, which may deform upon connection of the outlet body to the conduit in use. The seal may, for example, comprise a lip seal or the like.

At least one of the conduit and the outlet body may comprise a releasable catch for retaining the outlet body relative to the conduit in use. A releasable catch may provide a simple and cost-effective mechanism for retaining the outlet body relative to the conduit. The releasable catch may be configured, for example through material choice, to retain the outlet body relative to the conduit with sufficient force such that, in use, a pressure caused by emission of airflow and/or a pressure caused by airflow within the conduit does not cause unintended separation of the outlet body and the conduit.

The releasable catch may be located such that the releasable catch is not exposed to filtered airflow within the conduit in use. This may ensure that the releasable catch does not interfere with airflow through the conduit in use, for example reducing a risk of flow obstruction relative to an arrangement where a catch extends into the airflow through the conduit.

The conduit may comprise a plurality of releasable catches for retaining the outlet body relative to the conduit in use. The plurality of releasable catches may be arranged to cooperate with features of the outlet body to releasably retain the outlet relative to the conduit. The plurality of releasable catches may be located adjacent to edges of an aperture provided in the conduit that is covered by the outlet body in use. The plurality of releasable catches may be distributed around edges of an aperture provided in the conduit that is covered by the outlet body in use.

The outlet body may be connectable to the conduit by a friction fit. This may provide a simple mode of retention, and may ensure a secure fit such that airflow does not leak at the join between the conduit and the outlet body in use. The friction fit may be sufficient to retain the outlet body relative to the conduit in use. The friction fit may be combined with a further retention mechanism, for example a releasable catch as previously described, which may provide for increased security of connection.

The conduit may comprise a first end and a second end, and the air purifier assembly may be configured to provide filtered airflow to both the first and second ends of the conduit in use, such that first and second filtered airflows are conveyed within the conduit, and the nozzle assembly may be arranged to emit both the first and second filtered airflows.

In some examples, at least one of the conduit and the outlet body may be configured such that the first and second airflows collide in use before being emitted from the nozzle assembly through the air outlet.

In some examples, at least one of the conduit and the outlet body may comprise a divider for dividing the air outlet into first and second air outlet portions, and the divider may be configured to divert the first and second filtered airflows through a respective one of the first and second air outlet portions in use. This may be beneficial as it may provide a more stable airflow through the air outlet than, for example, an arrangement where the first and second filtered airflows are allowed to collide. The divider may divide the conduit into first and second conduit portions, with the first and second filtered airflows being conveyed through respective first and second conduit portions in use.

The air purifier assembly may comprise a first outlet aperture configured to emit a first filtered airflow to the first end of the conduit, and the air purifier assembly may comprise a further filter, a further airflow generator for creating a further airflow through the further filter, and a second outlet aperture configured to emit a second filtered airflow to the second end of the conduit.

An air purifier assembly comprising an airflow generator and a further airflow generator may enable use of airflow generators of a smaller size relative to a single airflow generator designed to provide the same total airflow, and smaller airflow generators may be easier to package.

The air purifier assembly may comprise first and second purifier assembly housings, with the airflow generator and the filter located within the first purifier assembly housing, and the further airflow generator and the further filter located within the second purifier assembly housing. The first and second purifier assembly housings may be located at opposing sides of the head wearable air purifier, for example at opposing ends of the headgear and opposing ends of the nozzle assembly. This may provide a weight balanced arrangement, which may provide comfort for a wearer in use.

According to a second aspect of the present invention there is provided a nozzle assembly for a wearable air purifier, the nozzle assembly comprising a conduit for receiving a filtered airflow, and an outlet body releasably connected to the conduit, the outlet body defining an air outlet for emitting filtered airflow from the nozzle assembly.

According to a third aspect of the present invention there is provided a wearable air delivery apparatus comprising a headgear; and a nozzle assembly supported by the headgear, the nozzle assembly comprising a conduit for receiving a filtered airflow from an air purifier assembly, and an outlet body releasably connected to the conduit, the outlet body defining an air outlet for emitting filtered airflow from the nozzle assembly.

Features of aspects of the present invention may be equally applied to other aspects of the present invention, where appropriate.

### BRIEF DESCRIPTION OF THE DRAWINGS

Embodiments of the invention will now be described, by way of example only, with reference to the accompanying drawings, in which:

FIG. 1 is a schematic front view of a wearable air purifier according to the present invention;

FIG. 2 is a schematic rear underside view of the wearable air purifier of FIG. 1;

FIG. 3 is a cross-sectional view of the wearable air purifier of FIG. 1 with a nozzle assembly removed;

FIG. 4 is a schematic rear view of a nozzle assembly of the wearable air purifier of FIGS. 1 and 2 in a disassembled configuration; and

FIG. 5 is a schematic rear view of a nozzle assembly of the wearable air purifier of FIGS. 1 and 2 in an assembled configuration.

### DETAILED DESCRIPTION OF THE INVENTION

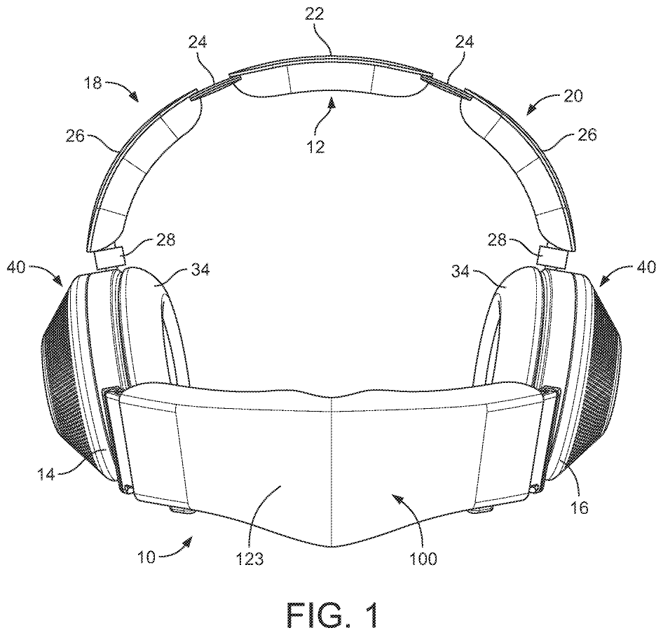

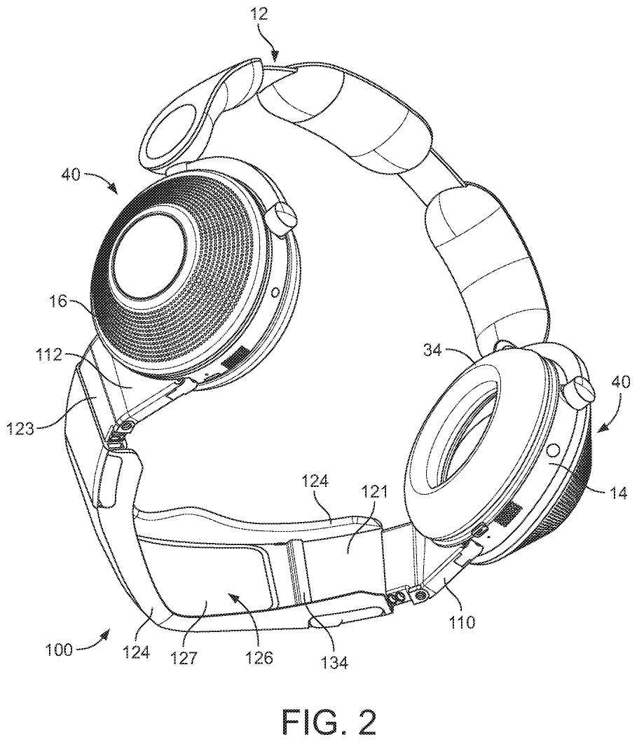

A wearable air purifier, generally designated 10, is shown schematically in FIGS. 1 and 2.

The wearable air purifier comprises a headgear 12, 14, 16, a purifier assembly 42,44, and a nozzle assembly 100.

The headgear has the form of headphones and comprises a headband 12 and first 14 and second 16 housings connected to respective ends of the headband 12. The headband 12, is generally elongate and arcuate in form, and is configured to overlie a top of a head of a wearer, and sides of the head of the wearer, in use. The first 14 and second 16 housings then comprise ear cups such as those typically used for so-called “over-the-ear” headphones, which are generally hemi-spherical and hollow in form.

The headband 12 has a first end portion 18, a second end portion 20, and a central portion 22. Each of the first 18 and second 20 end portions are connected to the central portion 22 by an extension mechanism. Each extension mechanism, as shown in FIGS. 1 and 2, comprises an arm 24 that engages with teeth internal of the first 18 and second 20 end portions to form a ratchet mechanism that enables adjustment of the length of the headband 12 by a wearer. To this end, the teeth, a spacing between the teeth and an opposing wall, or the arm 24 itself, may be sufficiently resilient to provide the required retention.

The first 18 and second 20 end portions of the headband 12 each comprise a hollow housing 26. The hollow housing 26 defines a battery compartment for receiving one or more batteries therein. It will be appreciated that batteries may be removable from the hollow housing 26, or may be intended to be retained within the hollow housing 26 during normal use. Where the batteries are replaceable and intended to be removable from the hollow housing 26, the hollow housing 26 may, for example, comprise a releasable door or cover to enable access to the interior of the hollow housing 26. Where batteries are rechargeable and intended to be retained within the hollow housing 26 in normal use, the hollow housing 26, or indeed other components of the wearable air purifier 10, may comprise at least one charge port to enable recharging of batteries.

The first 18 and second 20 end portions of the headband 12 are connected to respective ones of the first 14 and second 16 housings. In some examples, the first 18 and second 20 end portions of the headband 12 are connected to respective ones of the first 14 and second 16 housings such that relative movement is enabled between the first 18 and second 20 end portions of the headband 12 and the respective first 14 and second 16 housings. As shown in FIG. 1, a swivel pin 28 is used for such a connection, but it will be appreciated by a person skilled in the art that other forms of connection are possible. To enable electrical connection of batteries contained within the hollow housings 26 of the first 18 and second 20 end portions of the headband 12 to components internal of the first 14 and second 16 housings, the swivel pins 28 are hollow, for example to allow electrical wiring or the like to pass therethrough.

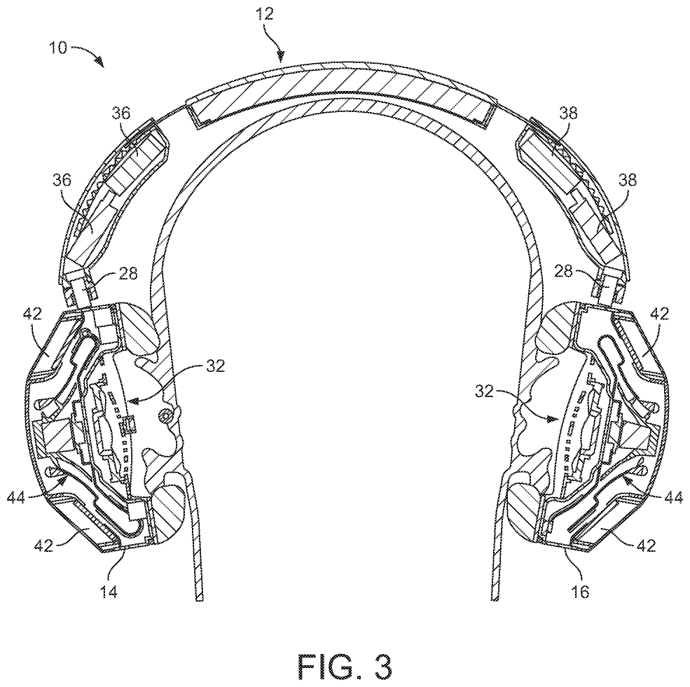

Each housing 14,16 houses a speaker assembly 32, as shown in FIG. 3, and comprises annular padding 34 configured to surround an ear of a wearer of the wearable air purifier 10. Details of the speaker assembly 32 are not pertinent to the present invention, and so will not be described here for the sake of brevity, but it will be recognised by a person skilled in the art that any appropriate speaker assembly may be chosen. In use, the speaker assemblies 32 received within the first 14 and second 16 housings are configured to receive power from all of the batteries 36,38. Power transfer wiring (not shown) runs through the headband 12 between the first 18 and second 20 end portions, for example through the central portion 22 and arms 24. Such an arrangement provides increased flexibility in power distribution between the speaker assemblies 32. In other embodiments the speaker assemblies 32 received within the first 14 and second 16 housings may be configured to receive power from batteries 36,38 disposed in respective ones of the first 18 and second 20 end portions of the headband 12. For example, a speaker assembly 32 received within the first housing 14 may be configured to be powered by the batteries 36 within the first end portion 18 of the headband 12, whilst a speaker assembly 32 received within the second housing 16 may be configured to be powered by batteries 38 within the second end portion 20 of the headband 12.

As shown in FIG. 3, the first 14 and second 16 housings of the headgear further house filter assemblies 42 and airflow generators 44 of the air purifier assembly. Each housing 14,16 then also provides ambient air inlets 40 and outlet apertures (not shown) for the air purifier assembly.

The ambient air inlet 40 provided by each of the first 14 and second 16 housings comprises a plurality of apertures through which air may be drawn into the interior of the housing 14,16.

Each filter assembly 42 is disposed within a respective housing 14,16 between the ambient air inlet 40 and a respective airflow generator 44. Each filter assembly 42 comprises a filter material chosen to provide a desired degree of filtration of air to be provided to a wearer in use.

The airflow generators 44 each comprise a motor driven impellers which draw air from the respective ambient air inlet 40, through the respective filter assembly 42, and output air through the respective outlet aperture (not shown), of the air purifier assembly that is provided by the respective housing 14,16. The airflow generator 44s in the first 14 and second 16 housings are configured to receive power from all of the batteries 36,38. Power transfer wiring (not shown) runs through the headband 12 as described above in relation to the speaker assemblies 32. In other embodiments, the airflow generator 44 within first housing 14 may be configured to be powered by batteries 36 within the first end portion 18 of the headband 12, whilst the airflow generator 44 in the second housing 16 may be configured to be powered by batteries 38 within the second end portion 20 of the headband 12.

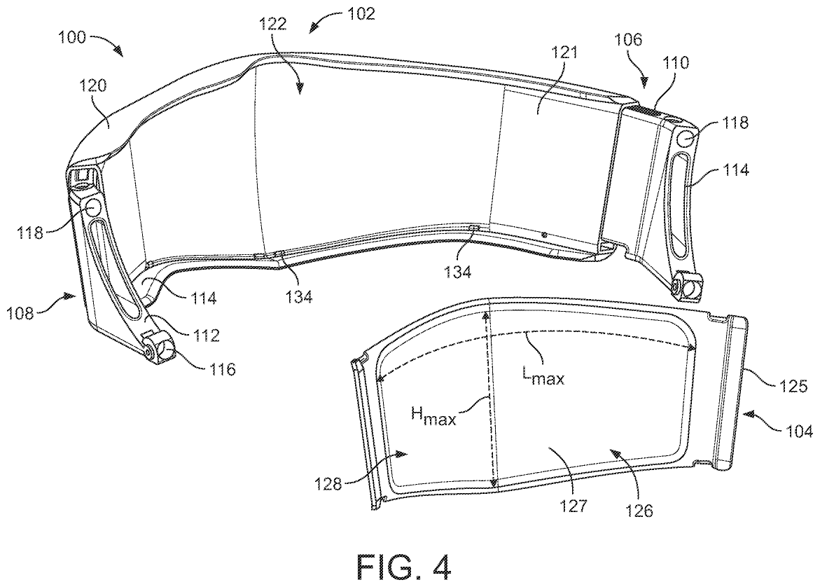

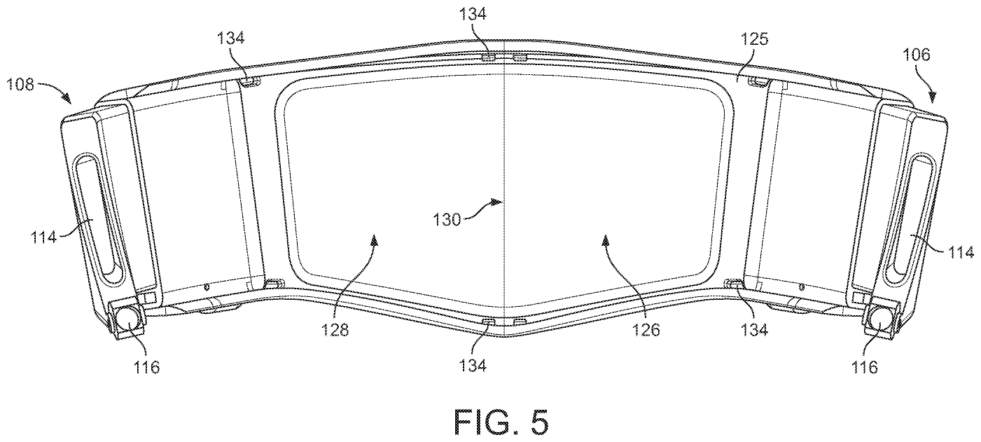

The nozzle assembly 100 is shown connected to the headgear in FIGS. 1 and 2, and is shown in isolation from the remainder of the headgear in FIGS. 4 and 5.

The nozzle assembly 100 comprises a conduit 102 and an outlet body 104. The conduit 102 has first 106 and second 108 ends, and is curved between the first 106 and second 108 such that the conduit 102 is generally arcuate in form. The first 106 and second 108 ends comprise respective first 110 and second 112 connector portions that connect to respective ones of the first 14 and second 16 housings of the headgear. When the nozzle assembly 100 is connected to the first 14 and second 16 housings, and the headgear is worn by a wearer, the nozzle assembly 100 is configured to extend in front of the face of the wearer, particularly the mouth and lower nasal region of the wearer, without contacting the face of the wearer.

As shown in FIG. 4, the connector portions 110,112 have curved ends which are curved to match an outer surface of the first 14 and second 16 housings. The first 110 and second 112 connector portions are generally hollow, and have inlet apertures 114 which are configured to be in fluid communication with outlet apertures provided by the first 14 and second 16 purifier assembly housings when the conduit 102 is connected to the first 14 and second 16 housings. As shown in the figures, the connector portions 110,112 comprise hinges 116 and magnetic detents 118 which respectively rotatably connect and retain the conduit 102 relative to the first 14 and second 16 housings. It will be appreciated that other forms of connection, for example fixed, movable, and/or removable, are also envisaged.

The conduit 102 further comprises a main body portion 120 that extends between the first 110 and second 112 connector portions. The main body portion 120 is arcuate, generally hollow, and has a main body aperture 122 that faces inwardly towards a void defined between the first 106 and second 108 ends of the conduit 102. Specifically, the main body portion 120 comprises a rearward facing side wall 121, for example a wall that faces inwardly towards the void defined between the first 106 and second 108 ends, and a forward facing side wall 123, for example a wall that faces outwardly away from the void defined between the first 106 and second 108 ends. The outlet body 104 is shaped and sized so as to fit over the main body aperture 122, for example such that edges of the outlet body 104 overlap with a perimeter of the main body aperture 122. Upper and lower surfaces of the main body portion 120 comprise flow guides 124 that extend rearwardly, for example toward a void defined between the first 106 and second 108 ends of the conduit 102, and act to guide filtered airflow emitted from the nozzle assembly 100 toward a mouth and nasal region of a face of a wearer in use. It is envisaged that the flow guides 124 may be formed of a resiliently deformable material such that wearer comfort is provided in the event of accidental contact with a face of a wearer in use.

The outlet body 104 is generally arcuate in form, with the curvature of the outlet body 104 generally matching the curvature of the main body portion 120 of the conduit 102. The outlet body 104 comprises a frame 125 defining an aperture and a mesh 127 that is supported by the frame 125 so as to cover the aperture. The frame 125 of the outlet body 104 then further comprises a divider 130 that divides the aperture into first 126 and second 128 air outlet portions. The outlet body 104 is shaped and dimensioned so as to fit on to the conduit 102 over the main body aperture 122, and collectively the outlet body 104 and the conduit 102 define a flow passage between the inlet apertures 114 and the air outlet portions 126,128. The divider 130 is shaped and dimensioned such that it splits the flow passage into first and second flow passage portions, such that first and second filtered airflows flow through the nozzle assembly 100 in use, before being passed to a wearer via the air outlet regions 126,128.

The mesh 127 defines an array of apertures that are distributed across the first 126 and second 128 air outlet portions, with the plurality of apertures each having an aperture size (for example a width or diameter) of from 50 μm to 150 μm. The apertures thereby define an air outlet of the nozzle assembly 100 through which the filtered airflow is emitted from the wearable air purifier 10. For example, the mesh could be provided by a woven open mesh fabric comprising fibres of a material that is preferably highly resistant to moisture and chemicals, such as polyethylene terephthalate (PET). The mesh of the first 126 and second 128 air outlet portions thereby constitute an outlet region of the outlet body 104, with this outlet region having a maximum length (Lₘₐₓ) (i.e. the arc length of the outlet region when curved) of approximately 125 mm and a maximum height (Hₘₐₓ) of approximately 60 mm. However, the maximum length may be at least 90 mm, and is preferably anything from 100 mm to 130 mm, and the maximum height may be at least 50 mm, and is preferably anything from 50 mm to 65 mm.

The outlet region of the outlet body 104 has a total open area, defined by the apertures, of approximately 5700 mm², and an open area of approximately 18%. However, the total open area may be anything from 4500 mm² to 6900 mm², and preferably anything from 4700 mm² to 6700 mm², and the open area may be anything from 15% to 28%, and preferably anything from 18% to 25%. These characteristics for the outlet region of the outlet body 104 provide that the nozzle assembly 100 has a large area, high restriction air outlet that creates a low velocity region of filtered air that covers a mouth and lower nasal region of the face of the wearer, reducing their exposure to ambient air and minimising the potentially detrimental effects of cross winds.

As an alternative, the outlet body 104 may comprise a panel rather than a frame, with the outlet region of the outlet body 104 being defined by an array of apertures formed, for example by micro-drilling, in the outlet body 104.

It will be appreciated that a tight fit is desirable between the conduit 102 and the outlet body 104, both for mechanical retention and to prevent leakage, and hence in some embodiments the outlet body 104 fits onto the conduit 102 over the main body aperture 122 with a friction fit. Where a friction fit alone is utilised for retention, the outlet body 104 may comprise a removal feature which a user can grasp to facilitate removal of the outlet body 104 from the main body aperture 122. In some embodiments a seal (not shown) may be provided to enhance the fit and/or reduce air leakage between the conduit 102 and the outlet body 104. As shown in FIGS. 4 and 5, the conduit 102 is provided with a number of catches 134, for example flexible, cantilevered hooks, that are located adjacent to edges of the main body aperture 122 and that cooperate with features of the outlet body 104 to releasably retain the outlet body 104 relative to the conduit 102. This may further enhance security of connection of the outlet body 104 to the conduit 102. The catches 134 are located out of the flow path of filtered airflow through the nozzle assembly 100 in use.

The releasable connection between the conduit 102 and the outlet body 104 may allow the outlet body 104 to be easily removed and separated from the conduit 102 to allow for cleaning of the outlet body 104. For example the outlet body 104 may be separated from the conduit 102 and placed in a cleaning solution, or placed under UV light, which may eliminate bacteria and/or other pollutants from the outlet body 104, thereby ensuring the filtered airflow emitted from the nozzle assembly 100 in use is as clean as possible for the wearer. Furthermore, such an arrangement may enable ease of cleaning for the conduit 102, and in some examples may enable ease of access to an interior of the conduit 102 for cleaning, for example via the main body aperture 122.

In use, the headgear is located on a head of a wearer such that the first 14 and second 16 housing are located over an ear of the wearer, and the nozzle assembly 100 extends in front of a mouth and lower nasal region of the face of the wearer, without contacting the face of the wearer. The airflow generators 44 are actuable to draw air through the ambient air inlet 40 provided by each of the first 14 and second 16 housings, through the filter assemblies 42, and expel filtered airflow through the outlet apertures into the inlet apertures 114 of the first 110 and second 112 connector portions of the conduit 102. Filtered airflow travels through the conduit as first and second filtered airflows, and is delivered from the nozzle assembly 100, via the first 126 and second 128 air outlet portions, to the wearer of the wearable air purifier 10. The speaker assemblies 32 may provide audio data to a user, for example in the form of music and the like, and alternatively or additionally may provide noise cancellation for noise caused by operation of the airflow generators 44.

Although depicted here with two airflow generators 44, each feeding one end of the nozzle assembly 100, it will be appreciated that in alternative embodiments only a single airflow generator 44 may be provided, which may either feed both or one of the ends of the nozzle assembly 100. In such an embodiment, the nozzle assembly 100 may still comprise the conduit 102 and releasable outlet body 104.

Furthermore, in the illustrated embodiments the filter assemblies 42 and airflow generators 44 of the air purifier assembly are housed within the housings 14,16 of the headgear (i.e. that form the earcups), and are therefore integral/built-in to the headgear such that the ambient air inlets 40 and outlet apertures 43 of the air purifier assembly are provided by these housing 14,16. However, it will be appreciated that in some embodiments the filter assemblies 42 and airflow generators 44 of the air purifier assembly may be housed within their own distinct purifier assembly housings, with the ambient air inlets and outlet apertures of the air purifier assembly then being provided by these purifier assembly housings.

In such embodiments, the purifier assembly housings then may or may not be supported by the headgear. For purifier assembly housings that are supported by the headgear, the nozzle assembly may be directly connected to the outlet apertures of the air purifier assembly, such that the nozzle assembly is indirectly connected to the headgear. Alternatively, the nozzle assembly may be directly connected to the headgear and fluidically connected to the outlet apertures of the air purifier assembly by ducting that is connected to the headgear. For purifier assembly housings that are not supported by the headgear, and are instead worn elsewhere on the body of wearer (e.g. on a belt or around the neck of the wearer), the nozzle assembly may be directly connected to the headgear and fluidically connected to the outlet apertures of the air purifier assembly by ducting that is connected to the headgear.

1. A wearable air purifier comprising:
a headgear;
an air purifier assembly, the air purifier assembly comprising a filter and an airflow generator for creating an airflow through the filter; and
a nozzle assembly comprising a conduit for receiving a filtered airflow from the air purifier assembly, and an outlet body releasably connected to the conduit, the outlet body defining an air outlet for emitting filtered airflow from the nozzle assembly.

2. The wearable air purifier as claimed in claim 1, wherein the air purifier assembly is supported by the headgear.

3. The wearable air purifier as claimed in claim 1, wherein the conduit comprises an aperture, and the outlet body is configured to extend over the aperture when the outlet body is connected to the conduit in use.

4. The wearable air purifier as claimed in claim 3, wherein the aperture is provided in a side wall of the conduit.

5. The wearable air purifier as claimed in claim 3, wherein the conduit is generally arcuate and thereby defines a void between a first end and a second end of the conduit, and the aperture faces inwardly towards the void.

6. The wearable air purifier as claimed in claim 1, wherein the outlet body comprises a plurality of apertures defining the air outlet.

7. The wearable air purifier as claimed in claim 1, wherein the outlet body comprises a mesh defining the air outlet.

8. The wearable air purifier as claimed in claim 1, wherein at least one of the conduit and the outlet body comprises a seal for sealing with the other of the outlet body and the conduit when the outlet body is connected to the conduit in use.

9. The wearable air purifier as claimed in claim 1, wherein at least one of the conduit and the outlet body comprises a releasable catch for retaining the outlet body relative to the conduit in use.

10. The wearable air purifier as claimed in claim 9, wherein the releasable catch is located such that the releasable catch is not exposed to filtered airflow within the conduit in use.

11. The wearable air purifier as claimed in claim 1, wherein the outlet body is connectable to the conduit by a friction fit.

12. The wearable air purifier as claimed in claim 1, wherein the conduit comprises a first end and a second end, and the air purifier assembly is configured to provide filtered airflow to both the first and second ends of the conduit in use, such that first and second filtered airflows are conveyed within the conduit, and the nozzle assembly is arranged to emit both the first and second filtered airflows.

13. The wearable air purifier as claimed in claim 12, wherein at least one of the conduit and the outlet body comprises a divider for dividing for dividing the air outlet into first and second air outlet portions, and the divider is configured to divert the first and second filtered airflows through a respective one of the first and second air outlet portions in use.

14. The wearable air purifier as claimed in claim 12, wherein the air purifier assembly comprises a first outlet aperture that is configured to emit a first filtered airflow to the first end of the conduit, and the air purifier assembly comprises a further filter, a further airflow generator for creating a further airflow through the further filter, and a second outlet aperture configured to emit a second filtered airflow to the second end of the conduit.
